(19) United States
(12) Patent Application Publication
(10) Pub. No.: US 2017/0241554 A1
(43) Pub. Date: Aug. 24, 2017

(54) A MINI VALVE FOR LOW PRESSURE APPLICATIONS CORE WITH EMBEDDED SEALING MATERIAL AND A DOUBLE INJECTION METHOD FOR MAKING SAME

(71) Applicant: Elysee Piping Systems Limited, London (GB)

(72) Inventor: Panos Protopapas, Kaimakli (Nicosia) (CY)

(21) Appl. No.: 15/504,742

(22) PCT Filed: Aug. 18, 2015
(86) PCT No.: PCT/IB2015/001388

§ 371 Date: Feb. 17, 2017

Related U.S. Application Data
(60) Provisional application No. 62/038,986, filed on Aug. 19, 2014.

(51) Int. Cl. F16K 5/04; B29C 45/16

(52) U.S. Cl. CPC F16K 5/0478; B29C 45/1676; B29L 2031/7506

(57) ABSTRACT

The invention in question is a sealing method for injection molded polypropylene plastic valves, allowing simple and safe sealing of the valve in closed, semi-open and open positions without having to manually add the sealing material, as well as the sealing rib related to the method. The type of valve comprises of two parts (see FIG. 1): a) The Valve Body (2) with inlet (7), outlet (8) and a chamber for the Valve Core (1) b) The Valve Core (1), with the handle (4), valve opening (6) and sealing material (3) The invented method is using double injection techniques to shape the polypropylene Valve Core (1) of the valve in the first injection stage and then apply the thermoplastic elastomer sealing material (3) to the surface of the polypropylene Valve Core (1) in the second stage. In this way the Valve Core (1) and the Sealing Material (3) is made as one part in one single process, but with two separate injection stages. The Sealing Material (3) which is adhered to the surface of the Valve Core (1) is creating a sealing barrier where there is interference between the Sealing Material (3) and the Valve Body (2). The actual sealing is made by a protruded Sealing Rib (5) at the edges of the area of the Sealing Material (3). The elastomer Sealing Rib (5), which will seal against the inner surface of the Valve Body (2), is carefully measured to ensure proper sealing in all open/closing stages, while at the same time not adding too much friction between the parts. This way proper sealing is achieved, without having to increase the torque required to open and close the valve.

### BACKGROUND

When producing fittings using injection methods, good quality is ensured by designing molds which fit the purpose and using materials, which combine required strength and processability. However, since the fitting is made up of several parts, with different properties due to their purpose, some fixed and some moving, the molded parts have to be assembled to create the final product. Assembly work can be time consuming and, due to complexity, in many cases involves manual work with a high cost. It is also needed to add quality control on the purchased parts (o-rings) to ensure supplier's quality is appropriate and on the final assembled parts to ensure that the o-rings are assembled correctly.

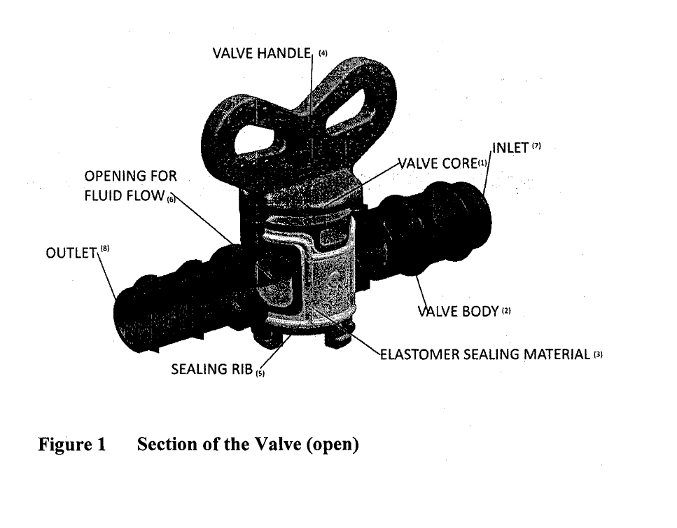

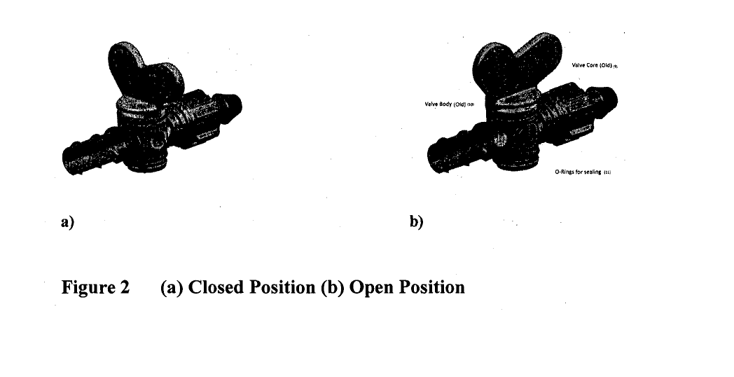

The original Mini Valve for Low Pressure Applications is made of three parts: The Valve Core (Old) (9), the Valve Body (Old) (10) and the four o-rings for sealing (11) (see FIG. 2). The Valve Core (Old) (9) and the Valve Body (Old) (10) are produced in-house, while the o-rings for sealing (11) are purchased from external suppliers.

The positioning of the o-rings is critical to the sealing of the valve; if one of the o-rings is out of position the valve will leak water. Since the o-rings are held in place by their own elasticity, automatic assembly which ensures correct sealing is extremely difficult and, if achieved, not cost effective. The operation is, therefore, done manually with customized assembly jigs.

Production is done in two steps:
a. The Valve Core (Old) (9) and the Valve Body (Old (10) are created separately by standard injection molding.
b. The 6 parts are manually assembled by:
   i. Threading the two large o-rings;
   ii. Pressing the small o-rings into the grooves (ensuring they do not fall out);
   iii. Inserting the Valve Core (Old) (9) with the o-rings for Sealing (11) into the Valve Body (Old) (10); and,
   iv. Securing the Valve Core (Old) (9) with the Valve Body (Old) (10) by a manual pressing device.

Though the process is simple, it is relatively time consuming and therefore costly compared to the added value of the assembly. There is also a risk that some of the o-rings are assembled wrongly, thus causing leakage, which then increases the need for quality controls to find possibly leaking Mini Valve for Low Pressure Applications.

The idea of the new invention is to produce the Valve Core and the Sealing Material in one process and thereby reduce the number for assembly steps by:
a. Ensuring that the sealing material is always in the correct position and of the appropriate quality, without having to make dedicated quality control steps to ensure proper sealing;
b. Designing a new locking mechanism of Body/Core for automatic assembly; and,
c. Removing the need for manual assembly of o-rings for Sealing (11).

The assembly is simplified to one step—simply inserting the Valve Core with the elastomer sealing material into the Valve Body. This way the assembly process can be automated easily.

### STATEMENT OF INVENTION

The Valve Core (Old) (9) of the standard Mini Valve for Low Pressure Applications is made of polypropylene, to ensure the properties required for endurance, stiffness and pressure resistance; the o-ring is made of a rubber material for sealing purposes. Due to the different materials, they cannot be produced together in a standard injection process, but have to be produced in two separate processes. To enable the sealing material and the Valve Core to be produced together, a New Valve Core (1) is designed, where the sealing material (3) will be adhered to the core, during a Double Injection operation.

The new Mini Valve for Low Pressure Applications has a cylindrical Valve Body (2) with an internal chamber with inlet (7) and outlet (8) openings. A two-component plastic New Valve Core (1) which is rotatable is positioned in the chamber to control the flow of fluid through the valve.

### Construction of New Mini Valve for Low Pressure Applications

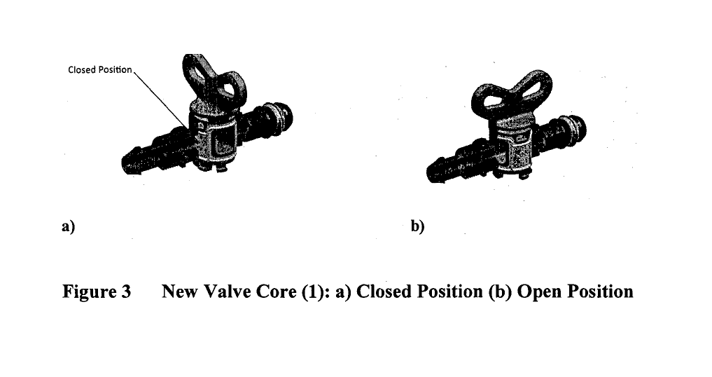

The two-component Valve Core (1) is made by polypropylene to which a thin layer of thermoplastic elastomer is added on the outer surface of the core by double injection techniques. More specifically, the thermoplastic elastomer is added on the interference surface of the Valve Core (1) to seal between the cylindrical Valve Body (2) and the Valve Core (1), so that we get a watertight sealing between the two parts. The thin layer of thermoplastic elastomer is following the cylindrical shape of the Valve Core (1) and the sealing is ensured by a continuous rectangular protrusion—the Sealing Rib (5) which is placed on each surface-edge connected all-around forming a rib to ensure proper sealing in both open and closed position (see FIG. 3). The dimensions of the rectangular rib are specific in order to achieve optimum sealing interference with effortless functionality, without increasing the required operational torque. The special designed layer of thermoplastic elastomer will ensure watertight control of both inlet and outlet radial openings of the Valve Body (2).

The Sealing Rib (5) of the Sealing Material (3) is also ensuring permanent water tightness in the direction of the insertion of the Valve Core (1). The flow of fluid through the valve is accommodated by a squared passage running radial through the Valve Core (1), which when in open position allows flow of a liquid throughout the Inlet (7) to the Outlet (8) openings of the cylindrical Valve Body (2).

The two-component plastic New Valve Core (1) extends upwards through the chamber where the open-close mechanism is and downwards where the locking mechanism is. The open-close mechanism operates with a special designed Valve Handle (4) which is an extension of the Valve Core (1) molded together as one part. The two-component plastic New Valve Core (1) has open and closed positions and any other position between, with the aim of controlling the delivered quantity of liquid. The mechanism locking the New Valve Core (1) to the Valve Body (2) is also an extension of the core, molded as a whole, and consists of four cantilever hooks which lock on the bottom of the cylindrical Valve Body (2) portion.

### Sealing Material Design

The body of the two-component plastic New Valve Core (1) has specially designed grooves for better bonding with the thermoplastic elastomer layer. The two-component plastic New Valve Core (1) is produced by a single molding process, using the double injection technique which allows molding and bonding two kinds of plastic materials through a single process but in a separate injection instance and location.

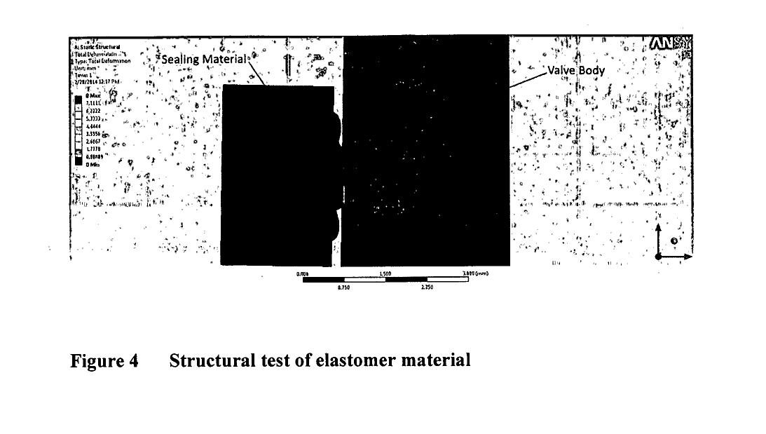

The material used in the Sealing Material (3) is an elastomer which will deform when being subjected to the pressure from the inner wall of the Valve Body (2) while inserting the Valve Core (1) to the Valve Body (2). The size of the sealing material protrusion is calculated to ensure that the deformation of the sealing material leaves a large enough surface with enough pressure onto the Valve Body (2) to ensure sealing under pressure of up to 8 Bar without increasing the friction between the parts so that opening/closing movements become difficult (FIG. 4).

1. A sealing rib, characterized by:
The pattern of the continuous sealing material and the rib around the body, to ensure proper sealing in all positions between full open and completely closed;
The shape of the profile, to ensure that the deformation of the rib when squeezed towards the valve body increases the sealing surface, while still allowing a smooth rotation of the valve core at the same time;
The depth and the shape of the sealing material filling the groove in the polypropylene core, to ensure enough elasticity of the sealing material to deform, to create a large enough sealing surface, while at the same time transferring some of the rigidity of the valve core to the sealing material, to ensure adequate sealing.

2. A sealing method for injection molded polypropylene plastic valves, through the use of double injection techniques to shape the polypropylene valve core of the valve, in the first injection stage, and, then, the application of a thermoplastic elastomer sealing material to the surface of the polypropylene valve core, in the second stage, such method being characterized by the following steps:
The sealing material, which is adhered to the surface of the valve core, is creating a continuous sealing barrier, where there is interference between the sealing material and the valve body;
The actual sealing is made by a protruded sealing rib at the edges of the area of the sealing material;
The elastomer sealing rib, which will seal against the inner surface of the valve body, is carefully measured to ensure proper sealing in all open/closing stages, while at the same time not adding too much friction between the parts;
This way proper sealing is achieved, without having to increase the torque required to open and close the valve;
As a result, the valve core and the sealing material are made as one part in one single process, but with two separate injection stages.
